(19) United States
(12) Patent Application Publication
(10) Pub. No.: US 2021/0231902 A1
(43) Pub. Date: Jul. 29, 2021

(54) APPARATUS FOR SHUFFLING MULTICORE FIBER CONNECTIONS

(71) Applicant: Nokia Solutions and Networks Oy, Espoo (FI)

(72) Inventor: Peter Winzer, Aberdeen, NJ (US)

(21) Appl. No.: 16/752,883

(22) Filed: Jan. 27, 2020

(51) Int. Cl. G02B 6/44

(52) U.S. Cl. CPC G02B 6/4472

(57) ABSTRACT

An apparatus including a fiber core shuffler device, the device including first optical connectors, second optical connectors and an optical distribution guide. Each of the first optical connectors configured to receive and mechanically hold an end segment of one of a plurality first multicore fibers. Each of the second optical connectors configured to receive and mechanically hold an end segment of one of a plurality of second multicore fibers. The optical distribution guide includes a plurality of optical waveguides. Each of the optical waveguides configured to guide light between a corresponding pair of ends of optical cores, one of cores of each one of the pairs belonging to one of the first multicore fibers and the other of the cores of the one of the pairs belonging to one of the second multicore fibers.

### TECHNICAL FIELD

This application is directed, in general, to optical apparatus and, more specifically, to optical apparatus for distributing connections between the cores of multicore optical fibers.

### BACKGROUND

This section introduces aspects that may help facilitate a better understanding of the inventions. Accordingly, the statements of this section are to be read in this light and are not to be understood as admissions about what is prior art or what is not prior art.

Data centers are often include racks of servers, with a switch (top-of-rack, TOR, switch) switching traffic between servers and aggregating the rack traffic for processing the traffic of an entire row. An end-of-row (EOR) switch often then handles the traffic per row, gradually going upwards in switching hierarchies. Often, servers are connected to such switches through electrical cables such as short reach digital attach cables (e.g., DACs, typically 3 m or shorter).

### SUMMARY

One embodiment is an apparatus including a fiber core shuffler device, the device including first optical connectors, second optical connectors and an optical distribution guide. Each of the first optical connectors can be configured to receive and mechanically hold an end segment of one of a plurality first multicore fibers. Each of the second optical connectors can be configured to receive and mechanically hold an end segment of one of a plurality of second multicore fibers. The optical distribution guide can include a plurality of optical waveguides. Each of the optical waveguides can be configured to guide light between a corresponding pair of ends of optical cores, one of cores of each one of the pairs belonging to one of the first multicore fibers and the other of the cores of the one of the pairs belonging to one of the second multicore fibers.

In some such embodiments, the optical waveguides of the optical distribution guide can: optically connect a pair of cores of one of the first multicore fibers to a pair of cores of one of the second multicore fibers, optically connect a second pair of cores of one of the first multicore fibers to a pair of cores of a different one of the second multicore fibers, or, optically connect a second pair of cores of the different one of the second multicore fibers to a pair of cores of a different one of the first multicore fibers.

In any such embodiments, each of the optical waveguides can include different single core fiber.

In any such embodiments, first ends of the optical waveguides can be physically arranged in a geometric pattern similar to a geometric pattern of the cores of a facing end of one of one of the first multicore fibers, and, second ends of the optical waveguides can be physically arranged in a geometric pattern similar to a geometric pattern of the cores of a facing end of one of one of the second multicore fibers.

In any such embodiments, the optical distribution guide can include optical fan-outs to optically couple to ends of the cores of the first multicore fibers and to the ends of the cores of the second multicore fibers to individual ones of the optical waveguides. In some such embodiments, some of the optical fan-outs can be structured to optically couple ends of the optical waveguides to match a pattern and pitch of the cores of one of the first multicore fibers and others of the optical fan-outs can be structured to optically couple ends of the optical waveguides to match a pattern and pitch of the cores of one of the second multicore fibers. In some such embodiments, the some of the optical fan-outs can include a glass block having optical input ports facing and optically coupling one of the nearby ends cores of one of the first multicore fibers to optical output ports of the glass block such that adjacent ones of the optical output ports can be separated from each other by a distance greater than a distance separating adjacent ones of the optical input ports, and, the other of the optical fan-outs can include a glass block having optical input ports facing and optically coupling one of the nearby ends cores of one of the second multicore fibers to optical output ports of the glass block such that adjacent ones of the optical output ports can be separated from each other by a distance greater than a distance separating adjacent ones of the optical input ports.

In any such embodiments, the optical distribution guide can further include optical switches optically connecting to some of the waveguides and being able to dynamically change optical connections between cores of the first and second multicore optical fibers. In some such embodiments, the optical switches can change a direction of optical beams traveling from the first optical connectors, or traveling from the first multicore fibers through the optical distribution guide. In some such embodiments, one or more of the optical switches of the optical distribution guide can includes a Micro-Electro-Mechanical System, a photonic integrated circuit or a liquid crystal on silicon device.

Any such embodiments can further include a harness that holds the fiber core shuffler device, the first multicore fibers, second multicore fibers and optical distribution guide to mechanically hold the connections between the optical waveguides and the first optical connectors and the second optical connectors.

Any such embodiments can further include an optical power supply optically connected to distribute optical power through at least one of the cores of one of the first multicore fibers or second multicore fibers.

Any such embodiments can further include the first multicore fibers, some of the multicore fibers having cores thereof arranged in a ring configuration around a central one of the cores.

Any such embodiments can further include a plurality of servers wherein one of the second connectors can be optically connected to a network interface card of one of the servers through one of the second multicore fibers.

Any such embodiments can further include a plurality of servers wherein individual ones of the second connectors can be optically connected to network interface cards of corresponding ones of the servers through the second multicore fibers.

In some embodiments, the fiber core shuffler device can be part of an optical communication system. The optical communication system can include a plurality of switches where one or more of the first optical connectors can be connected to one of the switches through one of the first multicore fibers and a plurality of servers where one or more of the second optical connectors can be connected to a network interface card of one of the servers through one of the second multicore fibers.

### BRIEF DESCRIPTION OF DRAWINGS

The embodiments of the disclosure are best understood from the following detailed description, when read with the accompanying FIGUREs. Some features in the figures may be described as, for example, “top,” “bottom,” “vertical” or “lateral” for convenience in referring to those features. Such descriptions do not limit the orientation of such features with respect to the natural horizon or gravity. Various features may not be drawn to scale and may be arbitrarily increased or reduced in size for clarity of discussion. Reference is now made to the following descriptions taken in conjunction with the accompanying drawings, in which:

FIG. 1 presents a block diagram of example embodiments of the apparatus of the disclosure;

FIG. 2 presents a plan view of an example embodiment of an end of a multicore fiber as used with embodiments the apparatus, such as the embodiments depicted in FIG. 1;

FIG. 3 presents a block diagram of example embodiments of a communication system including an embodiment the apparatus of the disclosure, such any of the apparatus embodiments disclosed in the context of FIG. 1;

In the Figures and text, similar or like reference symbols indicate elements with similar or the same functions and/or structures.

In the Figures, the relative dimensions of some features may be exaggerated to more clearly illustrate one or more of the structures or features therein.

Herein, various embodiments are described more fully by the Figures and the Detailed Description. Nevertheless, the inventions may be embodied in various forms and are not limited to the embodiments described in the Figures and Detailed Description of Illustrative Embodiments.

### DETAILED DESCRIPTION

The description and drawings merely illustrate the principles of the inventions. It will thus be appreciated that those skilled in the art will be able to devise various arrangements that, although not explicitly described or shown herein, embody the principles of the inventions and are included within its scope. Furthermore, all examples recited herein are principally intended expressly to be for pedagogical purposes to aid the reader in understanding the principles of the inventions and concepts contributed by the inventor(s) to furthering the art, and are to be construed as being without limitation to such specifically recited examples and conditions. Moreover, all statements herein reciting principles, aspects, and embodiments of the inventions, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

Some embodiments of the disclosure benefit from our recognition that some embodiments of the apparatus can eliminate or at least reduce hierarchy layers of switching as well as the associated hardware from data center architectures. Accordingly the apparatus may provide advantages by reducing one or more of interconnection latencies, cost and power use.

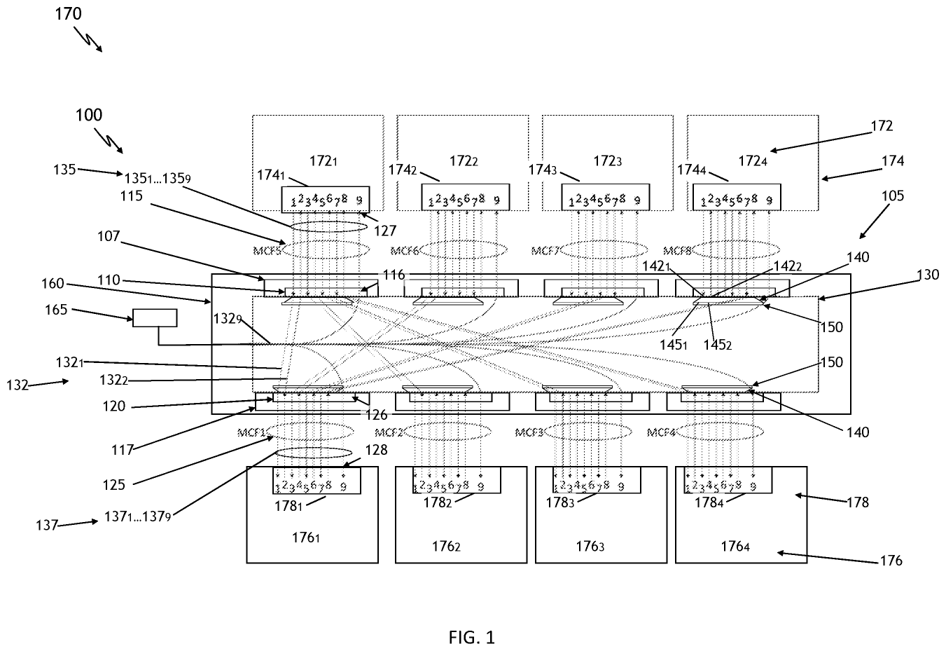

FIG. 1 presents a block diagram of an apparatus 100 embodiment of the disclosure. With continuing reference to FIG. 1 throughout, the apparatus 100 includes a fiber core shuffler device 105. The fiber core shuffler device includes first optical connectors 107 (e.g., a plurality of switch-side first optical connectors), each of the first optical connectors configured to receive and mechanically hold an end segment of one of a plurality first multicore fibers (MCF). E.g., each of the first optical connectors can have a plug or socket 110 to receive one of a plurality of first multicore fibers 115, e.g., end segments 116 of switch-side first MCF5 . . . MCF8. The fiber core shuffler device also includes second optical connectors 117 (e.g., a plurality of server-side second optical connectors), each of the second optical connectors configured to receive and mechanically hold an end segment of one of a plurality of second multicore fibers. In some embodiments, e.g., each of the second optical connectors can have a plug or socket 120 to receive one of a plurality of second multicore fibers 125, e.g., end segments 126 of server-side second MCF1 . . . MCF4. The fiber core shuffler device further includes an optical distribution guide 130, the guide 130 including a plurality of optical waveguides 132 (e.g., optical waveguides 132₁, 132₂), each of the optical waveguides configured to guide light between a corresponding pair of ends of optical cores, one of cores of each one of the pairs belonging to one of the first multicore fibers and the other of the cores of the one of the pairs belonging to one of the second multicore fibers. In some embodiments, e.g., each of the optical waveguides can be connected to the first optical connectors 107 and to the second optical connectors 117 such that each one of cores 135 (e.g., cores 135₁, 135₂, of the first multicore fibers 115 are separately connected to the different ones of cores 137 (e.g., cores 137₁, 137₂) of the second multicore fibers 125.

As illustrated, in some embodiments, an opposite end of the first multicore fibers 115 (e.g., ends 127 of MCF5 . . . MCF8) can be connected to photonic integrated circuits of the switches (e.g., PICs 174 of switches 172, (e.g., PICs 174₁, 174₂, . . . of switches 172₁, 172₂. . . ) and an opposite end of the second multicore fibers 125 (e.g., ends 128 of MCF1 . . . MCF4) can be connected to network interface cards of the servers (e.g., NICs 178 e.g., NICs 178₁, . . . of servers 176₁. . . ).

For clarity, FIG. 1 waveguide connections in the guide 130 are only shown in as far as they pertain to example optical connection of MCF1 and MCF5. In various embodiments, others of the multicore optical fibers of the two sets, i.e., the set MCF1-MCF4 and the set MCF5-MCF8, may have optical waveguide connections between individual optical cores of the multicore optical waveguides MCF1-MCF8 of the two sets.

The term, “optical distribution guide” as used herein means that there is an optical waveguide forming a guiding, all-optical, light path between the opposite end of the first multicore fiber (e.g., the end 127 of MCF5 . . . MCF8) and the opposite end of the second multicore fiber (e.g., the end 128 MCF1 . . . MCF4), such that the light traveling between the ends 127, 128 is not substantially altered other than by minor attenuation and or dispersion associated with light traveling the length of the end-to-end path (e.g., path lengths of about 10, 3 meters or less). E.g., the light entering one end (e.g., one of end 127 or end 128) of a switch or server connected MCF is not converted to an electrical signal and then back to light to exit the other end (e.g., the other of end 128 or end 127) of the other of the server or switch connected MCF. E.g., the light paths are all-optical paths and there is no optical-to-electrical-to-optical (OEO) conversion within the path. E.g., the light entering one end (e.g., one of end 127 or end 128) of a switch or server connected MCF is not optically converted, modulated or otherwise changed before exiting the other end (e.g., the other of end 128 or end 127) of the other of the server or switch connected MCF.

In various embodiments of the apparatus 100, the optical waveguides 132 of the guide 130 can be arranged to provide different types of static or dynamic optical connections between the cores of the switch and server connected MCFs 115, 125 and corresponding switch PICs 174 and server NICs 178 that the MCFs may be connected to.

For instance, in some embodiments, the optical waveguides of the guide can optically connect a pair of cores 135 of one of the first multicore fibers 115 (e.g., cores 135₁, 135₂ of MCF5) to a pair of cores 137 of one of the second multicore fibers 125 {e.g., cores137₁, 137₂ of MCF1). For instance, the optical waveguides of the guide can optically connect a second pair of cores 137 of the one first multicore fiber 125 (e.g., cores 135₃, 135₄ of MCF5) to a pair of cores 137 of a different one of the second multicore fibers 125 (e.g., cores 137₁, 137₂ of MCF 2). For instance, the optical waveguides of the guide can optically connect a second pair of cores 137 of the different one of the second multicore fibers 125 (e.g., cores 137₃, 137₄ of MCF2) to a pair of cores of a different one of the first multicore fibers (e.g., cores 135₃, 135₄ cores 3&4 of MCF6).

In some embodiments, e.g., to provide a static optical connection the optical waveguides 132 of the guide 130 can each be, or include, single core fibers. In some embodiments, the optical waveguides can be ridge, embedded, or other forms of optical waveguides familiar to those skilled in the pertinent arts.

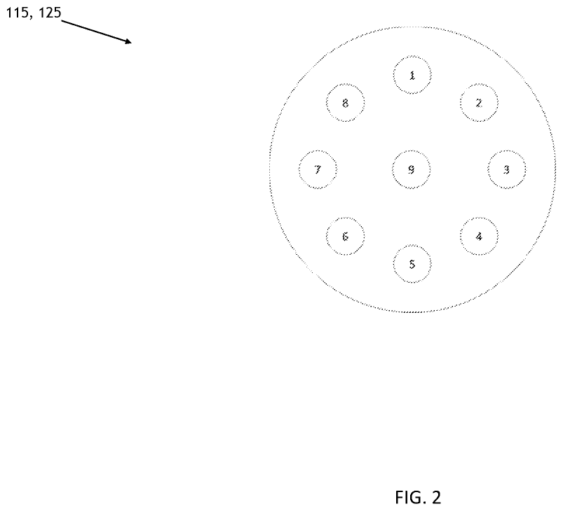

In some embodiments each of the optical waveguides 132 can be physically arranged to optically couple ends of the optical waveguides to match a pattern and pitch of the cores 135 of one of the first multicore fibers 115 or the cores 137 of one the second multicore fibers 125. For instance, consider an embodiment of first or second multicore fibers whose cores are distributed in the ring pattern and core-to-core pitches as presented in FIG. 2. For such an embodiment nearby and facing ends of the optical waveguides 132 can be arranged to have a ring pattern and core-to-core pitches to mirror the pattern and pitch of the MCF cores.

In some embodiments, the sizes and pitch of the cores of the MCFs may be too small to permit the optical waveguides (e.g., single core fibers) to be arranged to have the same pattern and pitch. In some such embodiments, to facilitate better optical power transfer between the MCFs and the optical waveguides 132, the guide 130 can include optical fan-outs 140 to individually optically couple ends of the cores 135 of the first multicore fibers 115, and/or ends of the cores 137 of the second multicore fibers 125, to individual ends of ones of the optical waveguides 132. For instance, embodiments of the guide 130 can include optical fan-outs 140 to optically couple the cores 135 of the first multicore fibers 115, or the cores 137 of the second multicore fibers 125, to individual ones of the optical waveguides 132 of the guides. For instance, each of the optical fan-outs can be structured to optically couple ends of the optical waveguides to match a pattern and pitch of the nearby ends of the cores of one of the first multicore fibers, and/or nearby ends the cores of one the second multicore fibers. For instance, the optical fan-outs can be or include a glass block have input ports 142₁, 142₂ . . . optically coupling the nearby ends of the 135 cores of one of the first multicore fibers 115, or nearby ends of the cores 137 of one of the second multicore fibers 125, to output ports 145₁, 145₂ of the glass block, such that adjacent ones of the output ports are separated from each other by a distance greater than a distance separating adjacent ones of the input ports.

In some embodiments, the guide 130 can include optical switches 150 (e.g., all-optical switches) that are able to dynamically change the optical connections between the cores 135, 137 of the switch and server MCFs 115, 125, e.g., without optical-to-electrical-to-optical conversion. For instance, in some embodiments, the all-optical switches 150 can change all-optical connections between the pair of cores 135 of one of the first multicore fibers 115 (e.g., cores 135₁ and 135₂ of MCF5) to a different pair of cores of the second multicore fibers (e.g., cores 135₃ and 135₄, cores 135₅ and 135₆, or cores 135₇ and 135₈ of MCF1) or to pairs of cores of a different one of the second multicore fibers (e.g., pairs of cores of MCF2 MCF3 or MFC40).

For instance, in some embodiments, the all-optical switches 150 can change all-connections between the second pair of cores of the one first multicore fiber (e.g., cores 135₃ and 135₄ of MCF5) to a different pair of cores of the different one of the second multicore fibers (e.g., e.g., cores 137₃ and 137₄, cores 137₅ and 137₆, or cores 137₇ and 137₈ of MCF2) or to pairs of cores of another one of the second multicore fibers (e.g., pairs of cores of MCF3 or MFC4).

For instance, in some embodiments, the all-optical switches 150 can change connections between the second pair of cores of the different one of the second multicore fibers (e.g., cores 137₃ and 137₄ of MCF2) to a different pair of cores of the different one of the first multicore fibers (e.g., cores 135₁ and 135₂ , cores 135₅ and 135₆ or cores 135₇ and 135₈ of MCF6) or to another one of the first multicore fibers (e.g., pairs of cores of MCF5, MCF7 or MCF 8.

In any such embodiments the optical switches 150 can change a direction of optical beams traveling from the first optical connectors, or traveling from the first multicore fibers through the optical distribution guide 130.

In any such embodiments, the optical switches 150 can be or include Micro-Electro-Mechanical System (MEMS), a photonic integrated circuit or a liquid crystal on silicon device, e.g., free-space all-optical switch.

Based on the present disclosure, one skilled in the pertinent arts would understand how such all-optical switches could be controlled to dynamically change the optical connectivity of the guide 130, e.g., as needed for a particular optical communication system.

Some embodiments of the apparatus 100 can further include a harness 160 or other structure that mechanically and rigidly holds the fiber core shuffler device 105, the first multicore fibers 115, second multicore fibers 125 and optical distribution guide 130 so as to rigidly secure the connections between the optical waveguides 132 and the first optical connectors 107 and the second optical connectors 117. For instance embodiments of the harness may include molded plastic or metal structures with recesses that mechanically and rigidly secure the fibers 115 and guide 130 therein.

Some embodiments of the apparatus 100 can further include an optical power supply 165 optically connected to distribute optical power through at least one of the cores 135, 137 of the first or second multicore fibers 115, 125. For instance, the optical power supply 165 can provide a single-wavelength or a few-wavelengths of, pulsed or CW, optical power. In some embodiments, the optical power supply 165 can serves as an external optical power source that acts as a light source for one or more optical transponders of the switch 172 and/or of NICs of the server 176 (e.g., PICs 174, NICs 178). In some embodiments, the optical power supply 165 may also be pulsed to provide a master clock signal throughout the apparatus 100.

In some embodiments, the first multicore fibers and/or the second multicore fibers can include the cores for optical data propagation arranged in a ring configuration, e.g., to minimize core-to-core crosstalk, and further include a central core for optical power distribution. For instance as illustrated in FIG. 2 cores 1 . . . 8 can be cores for optical data propagation and central core 9 can be for optical power distribution, (e.g., through core 135₉) optically connected to the optical power source 165. In some such embodiments, an even number of cores (e.g., cores 135₁, 135₃, 135₅, 135₇, of MCF5 . . . .MCF8 may propagate data from the switch PICs 174 towards the server NICs 176 and equal number of cores (e.g., cores 135₂, 135₄, 135₆, 135₈, of MCF5 . . . .MCF8) may propagate data from the server NICs 176 towards the switch PICs 174, and the central core (e,g., 135₉ of MCF5 . . . .MCF8 may propagate CW light or a periodic optical pulse train to the switch PICs 174 and server NICs 176. In some such embodiments, such as when a periodic optical pulse train is being used as a light source it may advantageous to interleave the pulses of the pulse train and the pulses of the data stream going towards the PICs 174 and NICs, 176 to reduce core-to-core crosstalk.

Although apparatus is described in the context of facilitating the interchange of optical data through the cores of eight core or multi-core fibers, in other embodiments, multi-core fibers may have another number of optical cores, e.g., two or greater optical cores.

The optical data can be carried by any of the common optical telecommunication wavelength band such as the Original, Short, Conventional, Long or Ultralong and may be optically encoded by via phase, intensity, and/or polarization of data modulation schemes as familiar to those skilled in the pertinent art.

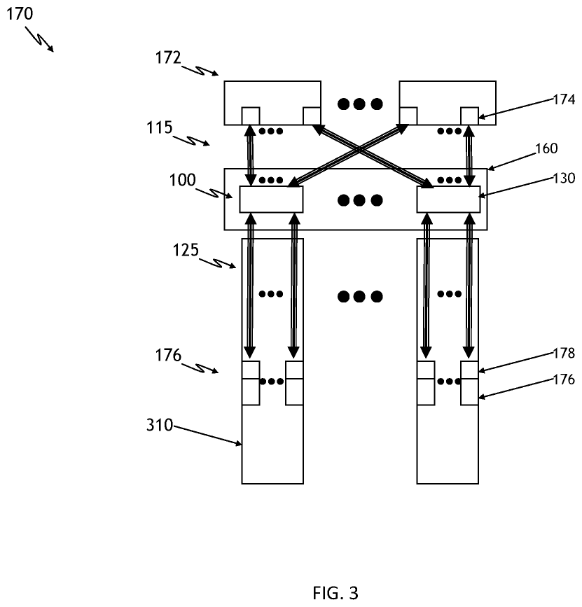

In some embodiments, the apparatus is part of an optical communication system. FIG. 3 presents a block diagram of example embodiments of an optical communication system 170 including any embodiments the apparatus 100 as discussed in the context of FIG. 1.

With continuing reference to FIGS. 1 and 3, the system 176 can include a plurality of switches e.g., all-optical types of switches 172₁ . . . ) where each one of the first optical connectors 107 of the apparatus 100 is connected to one of the switches 172 (e.g., by a PIC 174 thereof) through one of the first multicore fibers 115 (e.g., one of MCF5 . . . MCF8). The system 176 can also include a plurality of servers 176 (e.g., servers 176₁ . . . ), wherein each one of the first optical connectors 117 is connected to one of the servers (e.g., by a NIC 178 thereof) through one of the second multicore fibers 125 (e.g., one of MCF1 . . . MCF4), e.g., through some optical cores of the second multicore fiber 125. As illustrated the plurality of servers 176 can be housed in one or more cabinets 310. As a non-limiting example, for an optical communication system 170 configured as a data center, each of 40 servers 176 may have a total NIC traffic of 100 Gbps, and optical modulation may occur at 25 Gbps, i.e., 4×25 Gbps per NIC.

Some embodiments of the optical distribution guide 130 of FIG. 1 or 3 may also be used to interconnect optical transmitter, receiver, or transceiver chips, e.g., as described in U.S. patent application Ser. No. 16/688144, filed Nov. 19, 2019, by Peter Winzer, Po Dong, and David Neilson, to network interface cards of electronic data servers, e.g., located in one data center. In such embodiments, some or all of the optical cores of a multicore optical fiber 125 may, e.g., connect one or more data servers to one or more of said chips, e.g., to support optical communications between the electronic data servers inside a data center. U.S. patent application Ser. No. 16/688144 is incorporated herein by reference, in its entirety.

Those skilled in the art to which this application relates will appreciate that other and further additions, deletions, substitutions and modifications may be made to the described embodiments.

What is claimed is:

1. An apparatus, comprising:
a fiber core shuffler device, the fiber core shuffler device including:
first optical connectors, each of the first optical connectors configured to receive and mechanically hold an end segment of one of a plurality first multicore fibers;
second optical connectors, each of the second optical connectors configured to receive and mechanically hold an end segment of one of a plurality of second multicore fibers; and
an optical distribution guide, the optical distribution guide including a plurality of optical waveguides, each of the optical waveguides configured to guide light between a corresponding pair of ends of optical cores, one of cores of each one of the pairs belonging to one of the first multicore fibers and the other of the cores of the one of the pairs belonging to one of the second multicore fibers.

2. The apparatus of claim 1, wherein the optical waveguides of the optical distribution guide:
optically connect a pair of cores of one of the first multicore fibers to a pair of cores of one of the second multicore fibers,
optically connect a second pair of cores of one of the first multicore fibers to a pair of cores of a different one of the second multicore fibers, or,
optically connect a second pair of cores of the different one of the second multicore fibers to a pair of cores of a different one of the first multicore fibers.

3. The apparatus of claim 1, wherein each of the optical waveguides include a different single core fiber.

4. The apparatus of claim 1, wherein first ends of the optical waveguides are physically arranged in a geometric pattern similar to a geometric pattern of the cores of a facing end of one of one of the first multicore fibers, and, second ends of the optical waveguides are physically arranged in a geometric pattern similar to a geometric pattern of the cores of a facing end of one of one of the second multicore fibers.

5. The apparatus of claim 1, wherein the optical distribution guide includes optical fan-outs to optically couple to ends of the cores of the first multicore fibers and to the ends of the cores of the second multicore fibers to individual ones of the optical waveguides.

6. The apparatus of claim 5, wherein some of the optical fan-outs are structured to optically couple ends of the optical waveguides to match a pattern and pitch of the cores of one of the first multicore fibers and others of the optical fan-outs are structured to optically couple ends of the optical waveguides to match a pattern and pitch of the cores of one of the second multicore fibers.

7. The apparatus of claim 5, wherein the some of the optical fan-outs include a glass block having optical input ports facing and optically coupling one of the nearby ends cores of one of the first multicore fibers to optical output ports of the glass block such that adjacent ones of the optical output ports are separated from each other by a distance greater than a distance separating adjacent ones of the optical input ports, and, the other of the optical fan-outs include a glass block having optical input ports facing and optically coupling one of the nearby ends cores of one of the second multicore fibers to optical output ports of the glass block such that adjacent ones of the optical output ports are separated from each other by a distance greater than a distance separating adjacent ones of the optical input ports.

8. The apparatus of claim 1, wherein the optical distribution guide further includes optical switches optically connecting to some of the waveguides and being able to dynamically change optical connections between cores of the first and second multicore optical fibers.

9. The apparatus of claim 8, wherein the optical switches change a direction of optical beams traveling from the first optical connectors, or traveling from the first multicore fibers through the optical distribution guide.

10. The apparatus of claim 8, wherein one or more of the optical switches of the optical distribution guide includes a Micro-Electro-Mechanical System, a photonic integrated circuit or a liquid crystal on silicon device.

11. The apparatus of claim 1, further including a harness that holds the fiber core shuffler device, the first multicore fibers, second multicore fibers and optical distribution guide to mechanically hold the connections between the optical waveguides and the first optical connectors and the second optical connectors.

12. The apparatus of claim 1, further including an optical power supply optically connected to distribute optical power through at least one of the cores of one of the first multicore fibers or second multicore fibers.

13. The apparatus of claim 1, further including the first multicore fibers, some of the multicore fibers having cores thereof arranged in a ring configuration around a central one of the cores.

14. The apparatus of claim 1, wherein the apparatus further includes:
a plurality of servers wherein one of the second connectors is optically connected to a network interface card of one of the servers through one of the second multicore fibers.

15. The apparatus of claim 1, wherein the apparatus further includes:
a plurality of servers wherein individual ones of the second connectors are optically connected to network interface cards of corresponding ones of the servers through the second multicore fibers.

16. The apparatus of claim 1, wherein the fiber core shuffler device is part of an optical communication system, the system including:
a plurality of switches wherein one or more of the first optical connectors is connected to one of the switches through one of the first multicore fibers; and
a plurality of servers wherein one or more of the second optical connectors is connected to a network interface card of one of the servers through one of the second multicore fibers.
